(19) United States
(12) Patent Application Publication
(10) Pub. No.: US 2012/0018307 A1
(43) Pub. Date: Jan. 26, 2012

(54) Device and method for cleaning oil

(75) Inventors: Fabrizio D'AGOSTINO, (US); Hans OVERGAAG, (US)

(73) Assignee: ANSALDO ENERGIA S. P. A., Genova (IT)

(21) Appl. No.: 13/116,684

(22) Filed: May 26, 2011

(30) Foreign Application Priority Data
May 27, 2010 (IT) MI2010A 000950

(51) Int. Cl. B03C 5/02; C10G 32/02

(52) U.S. Cl. 204/555; 204/660; 204/661; 204/666; 204/556

(57) ABSTRACT

An oil cleaning device is provided with: at least a first electrostatic cleaner comprising at least one voltage source, and at least two metal plates connected to said voltage source; and

at least one free radical sensor for determining the content and/or type of free radicals in the oil.

The present invention relates to a device and method for cleaning oil. In particular, the present invention relates to a device and method for cleaning lubricant oil which can be used in an industrial plant, for example.

### BACKGROUND OF THE INVENTION

In use, lubricant oils are often subject to degradation phenomena generated upon oxidation processes and mechanical stresses, for example. These degradation phenomena determine the formation of insoluble contaminant particles, precursors of the formation of sludge, waxes, paints, etc.

The presence of contaminant particles does not ensure the correct operation of the rotating parts of the industrial plant, with evident disadvantages from the point of view of plant reliability and efficiency. The contaminant particles, indeed, tend to aggregate and precipitate to the polar surface of the plant, such as for example on the metal parts of servo valves, sealing bearings, pumps and filters, thus causing malfunctions.

Oil cleaning devices are known, comprising a cleaning tank provided with electric plates connected to a voltage source. These devices take advantage of electrostatic attraction to determine the precipitation of the contaminant particles in the oil. The contaminant particles under the bias of the electric field tend to aggregate and precipitate at the electric plates because of their polar nature. The particles are then captured by cleaner elements conveniently positioned at the electric plates.

However, this cleaning technique appears not particularly effective, especially when cleaning modern oils used for lubricating industrial plants.

### SUMMARY OF THE INVENTION

It is thus an object of the present invention to provide an oil cleaning device free from the disclosed faults of the prior art. In particular, it is an object of the present invention to provide an oil cleaning device which effectively eliminates the contaminant particles in the oil.

In accordance with these objects, the present invention relates to an oil cleaning device comprising:

at least a first electrostatic cleaner comprising at least one voltage source, and at least two metal plates connected to said voltage source; and

at least one free radical sensor for determining the content and/or type of free radicals in the oil.

It is a further object of the present invention to provide an oil cleaning method which is simple and effective.

In accordance with these objects, the present invention relates to an oil cleaning method comprising the steps of:

cleaning the oil by means of at least a first electrostatic cleaner comprising at least one voltage source, and at least two metal plates connected to said voltage source; and

determining the content and/or type of free radicals in the oil.

### BRIEF DESCRIPTION OF THE DRAWINGS

Further features and advantages of the present invention will be apparent from the following description of a non-limitative embodiment thereof, with reference to the figures in the accompanying drawings, in which:

FIG. 1 is a diagrammatic view, with parts removed for clarity, of an oil cleaning device according to the present invention in accordance with a first embodiment;

FIG. 2 is a diagrammatic view, with parts removed for clarity, of an oil cleaning device according to the present invention in accordance with a second embodiment;

FIG. 3 is a flow chart related to particular steps of the oil cleaning method according to the present invention.

### DETAILED DESCRIPTION OF THE INVENTION

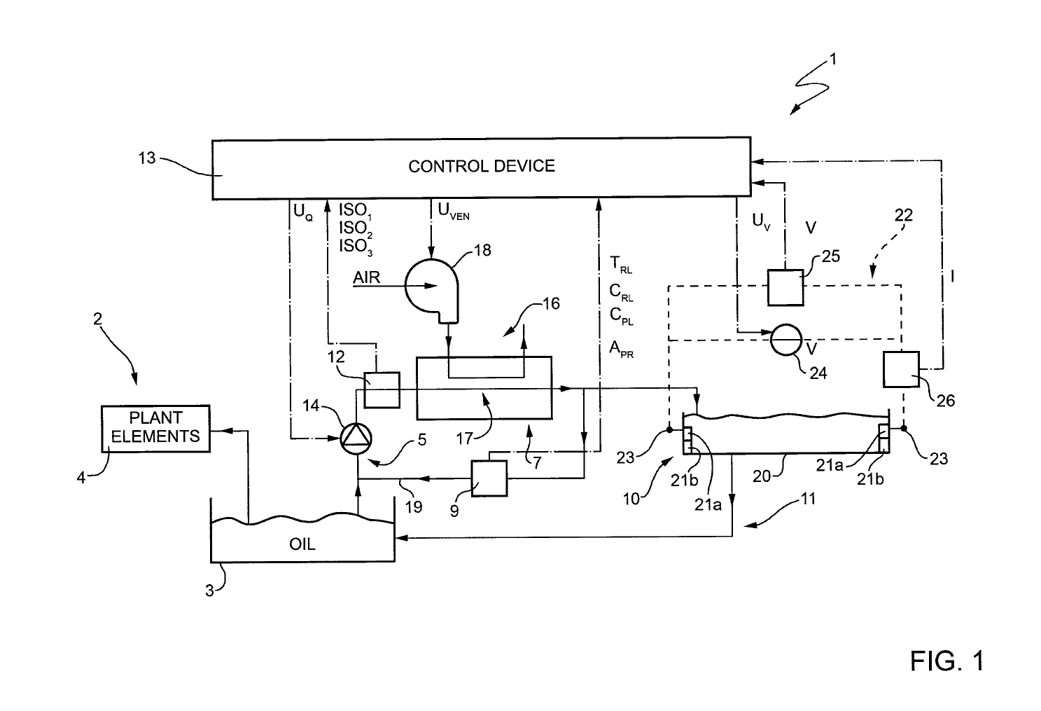

In FIG. 1, reference numeral 1 refers to an oil cleaning device. In particular, device 1 is configured for cleaning lubricating oil, which can be used in an industrial plant, for example.

The cleaning device 1 is connected to an industrial plant 2, e.g. to a plant for the production of electricity, which comprises a tank 3 containing lubricant oil and a plurality elements of the plant 4, which use the oil collected in the tank as lubricant. In the attached figures, the plurality of elements 4 are diagrammatically represented by a box.

The lubricating oil contained in tank 3 is usually at a temperature ranging from ambient temperature (when plant 2 is off) to about 60-80° C. (when plant 2 is on).

Cleaning device 1 comprises a delivery line 5, a heat exchanger 7, a free radical sensor 9, an electrostatic cleaner 10, a return line 11 configured to feed tank 3 with the oil from the electrostatic cleaner 10, a particulate counter 12, and a control device 13.

Delivery line 5 comprises a pump 14 and connects tank 3 to heat exchanger 7. Pump 14 is controlled by control device 13 by means of a control signal U₀ for drawing a given flow rate of oil from tank 3. In particular, pump 14 is a positive displacement-type pump.

Heat exchanger 7 is an air exchanger and comprises an air circuit 16, an oil circuit 17 and a ventilator 18. Ventilator 18 takes in air from the outside and conveys it into the air circuit 16. In particular, the ventilator speed is regulated by control device 13 which, by means of the control signal U_{VEN}, controls the ventilator 18 so that it turns at a given speed. The air speed in the heat exchanger affects the exchange efficiency. The higher the speed of ventilator 18, the greater the cooling effect of the oil.

The oil is preferably cooled to a temperature of about 40-45° C.

The oil cooling increases the cleaning effect of electrostatic cleaner 10, because it promotes the agglomeration of the contaminant particles.

The free radical sensor 9 detects and quantifies the presence of free radicals in the oil which flows therethrough.

In the non-limitative example described and illustrated here, the free radical sensor 9 is arranged along a by-pass line 19, which extends between a point downstream of heat exchanger 7 and a point upstream of pump 14.

By means of the free radical sensor 9, the presence of contaminant particles in the oil may be quantified, such as sludge, waxes, etc., mainly generated upon oxidation processes and mechanical stresses. The contaminant particles, indeed, comprise molecules provided with unpaired, highly reactive electrons, generally indicated by the term “free radicals”.

The free radical sensor 9 is preferably an electron spin resonance spectrometer, which detects the resonance frequency and the resonance peak amplitude of the electron spin, and calculates therefrom the composition and content of free radicals in the oil. In particular, the free radical sensor 9 can detect either an absolute amount or a relative amount of free radicals (concentration of free radicals in the oil).

The free radical sensor 9 substantially comprises a resonance chamber in which the oil is conveyed and radiated with a variable frequency magnetic field, comprised in the microwave range.

Under the effect of the magnetic field, the unpaired electrons may be subjected to resonant transitions between spin-up state and spin-down state. The frequency of the magnetic field at which this resonant transition occurs is detected to determine the amount and type of free radicals according to the following relation:

hv=gBH

where:
h is the Planck constant
B is the Bohr magnetone
V is the resonance frequency
H is the applied magnetic field
g is a characteristic parameter of the free radical (s)

In essence, once the frequency at which the resonance peak occurs has been identified, the sensor determines the value of parameter g so as to identify the free radical type T_{RL}.

The resonance peak amplitude determines, instead, the free radical concentration C_{RL} in the oil.

The free radical sensor 9 further detects the polar liquid concentration C_{PL} in the oil, e.g. water.

The data detected by the free radical sensor 9 (free radical type T_{RL}, free radial concentration C_{RL} and polar liquid concentration C_{PL}) are sent to the control device 13. Furthermore, the free radical sensor 9 sends the detected resonance peak amplitude A_{PR} to the control device 13.

The electrostatic cleaner 10 comprises a vessel 20, a plurality of metal plates 21a and a plurality of cleaner elements 21b.

Metal plates 21a and cleaner elements 21b are arranged along the inner walls of vessel 20. In particular, the metal plates 21 are connected to an electric circuit 22, and the cleaner elements 21b are coupled to respective metal plates 21a.

In the non-limitative example described and illustrated here, there are two metal plates 21a respectively connected to two terminals 23 of electric circuit 22, to which a voltage V generated by a voltage source 24 is applied.

Voltage V determines a polarization of metal plates 21a, which attract the contaminant particles having opposite polarity, and hold them. The particles are then captured by the cleaner elements 21b conveniently positioned at the electric plates 21a.

The metal plates 21a are then removed, the contaminated particles are cleaned off, and the metal plates 21a are then used again, while the cleaner elements 21b are replaced.

The value of voltage V is regulated by the control device 13, which controls the voltage source 24 by means of the control signal U_{V}.

In particular, the control device 13 is configured so as to determine an increase of voltage V when the cleaning effect of the electrostatic cleaner needs to be increased.

Electric circuit 22 is provided with a voltage meter 25 and a current meter 26, which are configured to send the respective determinations V and I to the control device 13 in order to optimize the oil cleaning and reduce scintillation phenomena.

According to a variant (not shown), the electric circuit 22 comprises a transformer and the current measurement is derived from a voltage measurement made in the transformer.

The particulate counter 12 is preferably arranged along delivery line 5 downstream of pump 14 and is configured to detect the amount of particulate in the oil. In particular, particulate counter 12 is configured to provide measurements in accordance with the various standards, such as for example ISO, NAS or AS. In the non-limitative example described and illustrated here, the particulate counter 12 is configured to provide the measurements according to ISO 4406-1999, which contemplates the detection of three data:

ISO1=number of particles larger than 4 microns and smaller than 6 microns;

ISO2=number of particles larger than 6 microns and smaller than 14 microns;

ISO3=number of particles larger than 14 microns.

A particulate counter 12 of this type is the product ICM made by MPfiltri, for example.

The control device 13, as already mentioned, receives the input determinations of the free radical sensor 9 (T_{RL}, C_{RL}, C_{PL}, A_{PR}) and the values of voltage V and current I determined by the voltage meter 25 and the current meter 26, respectively.

The control device 13 is configured to send the control signals U_{Q}, U_{VEL}, U_{C V} to pump 14, ventilator 18 and voltage source 24, respectively, according to the detections of the free radical sensor 9.

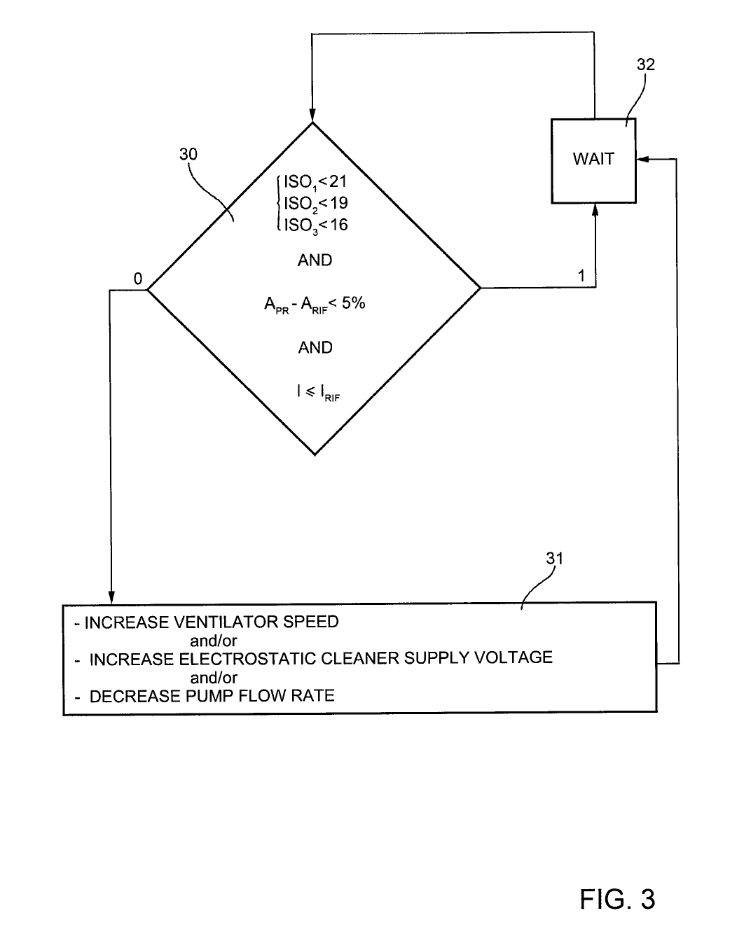

In particular, with reference to the flow chart in FIG. 3, control device 13 is configured to check the following conditions (block 30):

1) ISO1<21; ISO2<19; ISO3<16

2) A_{PR}-A_{RIF}<5%

3) I≦I_{RIF}

Where:
A_{RIF} is the value of the resonance peak amplitude determined by the free radical sensor 9 on clean oil. This value depends on the type of oil used.
I_{RIF} is the value of the current determined by the current meter on clean oil. This value also depends on the type of oil used.

When at least one of the above-listed conditions 1), 2) and 3) is not satisfied, the control device 13 carries out measurements to determine the cleaning effect (block 31). If, instead, all conditions 1), 2) and 3) are satisfied, the cleaning device 13 waits for a predetermined period of time (block 32), preferably about one hour, before checking conditions 1), 2) and 3) again.

In particular, the measurements for increasing the cleaning effect are substantially as follows:
increasing the speed of ventilator 18; and/or
increasing the supply voltage of electrostatic cleaner 10; and/or
decreasing the flow rate of the input oil to electrostatic cleaner 10.

These actions may be carried out independently from one another, and therefore they do not necessarily need to be carried to all at once to increase the cleaning effect.

More in detail, the step of increasing the speed of ventilator 18 includes the control device 13 sending the control signal U_{VEL} to ventilator 18 for controlling an increase of the speed of ventilator 18 such as to determine a decrease of the oil temperature below a predetermined value. In the non-limitative example described and illustrated here, the predetermined value is about 43° C.

The step of increasing the supply voltage of electrostatic cleaner 10 includes the control device 13 sending the control signal U_{V} to voltage source 24, so that the voltage increases to a predetermined value. The predetermined voltage value is obtained from a table of voltage values expressed as a function of the detected amount and/or type of free radicals. Such a table is preferably experimentally for each type of oil used.

Finally, the step of decreasing the flow rate of input oil to the electrostatic cleaner 10 includes the control device 13 sending the control signal U_{Q} to pump 14 for decreasing the flow rate of input oil to the electrostatic cleaner 10, so as to facilitate the oil cleaning in the electrostatic cleaner.

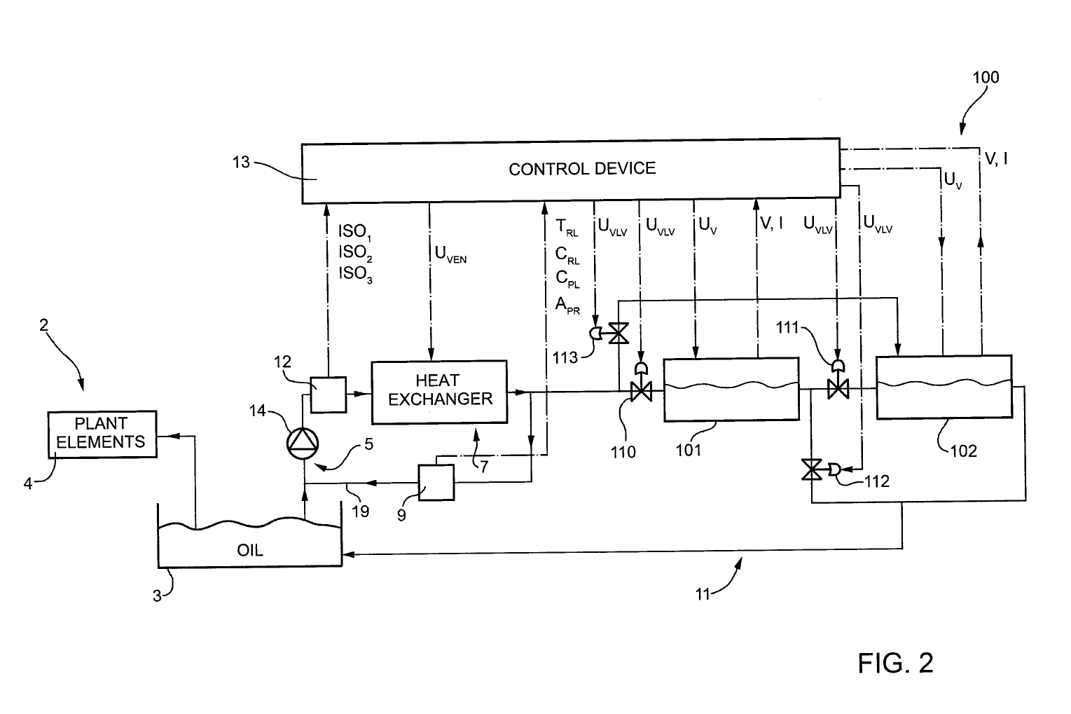

FIG. 2 shows a cleaning device 100 in accordance with a second embodiment, in which the same reference numbers are used to indicate parts similar to those of the cleaning device 1 shown in FIG. 1. Cleaning device 100 substantially differs from cleaning device 1 due to the presence of two electrostatic cleaners 101 and 102, which are substantially identical to the previously described electrostatic cleaner 10.

The two electrostatic cleaners 101 and 102 are connected to each other so as to operate according to three different modes: individual, serial or parallel modes.

In particular, the first electrostatic cleaner 101 is connected to the delivery circuit 5 by means of a valve 110, to the second electrostatic cleaner 102 by means of a valve 111, and to the return circuit 11 by means of a valve 112.

The second electrostatic cleaner 102 is connected to the delivery circuit 5 by means of a valve 113, to the first electrostatic cleaner 101 by means of a valve 111, and to the return circuit 11.

The individual operating mode provides that that the oil flows through only one of the two electrostatic cleaners 101 is 102. Therefore, the individual operating mode includes two configurations: a first configuration, in which valve 110 is closed and valve 113 is open, and a second configuration, in which valve 110 and valve 112 are open, while valves 111 and 113 are closed.

The serial operating mode includes the oil flowing through the first electrostatic cleaner 101 and then the second electrostatic cleaner 102. In particular, such a mode includes valves 110, 111 and 113 being open while valve 112 is closed.

The parallel operating mode includes the oil simultaneously flowing through the first electrostatic cleaner 101 and the second electrostatic cleaner 102. In particular, such a mode includes valves 110, 112 and 113 being open, while valve 111 is closed.

When control device 13 detects that at least one of the above-listed conditions 1), 2) or 3) is not satisfied, the control device 13, in addition to taking one or more measures for increasing the cleaning effect indicated at block 31 in FIG. 3, controls the switching from individual mode to serial mode, if the initial mode was the individual mode, or controls the switching from parallel mode to serial mode, if the initial mode was parallel.

Switching from one operating mode to the other is carried out under the bias of the control device 13 by means of appropriate control signals U_{VLV} sent to valves 110, 111, 112, 113.

Device 1, 100 according to the present invention advantageously allows regulating the cleaning action according to the real contamination of the oil to be cleaned.

The free radical sensor 9, indeed, determines the amount and type of contaminant particles, and the control device 13 regulates pump 14, ventilator 18 and voltage source 24 of electrostatic cleaner 10 so as to optimize oil cleaning.

It is finally apparent that changes and variations may be made to the device and method for cleaning oil described herein, without departing from the scope of the appended claims.

1. An oil cleaning device comprising:
at least a first electrostatic cleaner (10; 101, 102) comprising at least a voltage source (24), and at least two metal plates (21) connected to said voltage source (24); and
at least a free radical sensor (9) for determining the content and/or type of free radicals in the oil.

2. A device as claimed in claim 1, wherein the free radical sensor (9) is located upstream from the first electrostatic cleaner (10; 101, 102).

3. A device as claimed in claim 1, and comprising a control device (13) configured to adjust the voltage of the voltage source (24) of the first electrostatic cleaner (10; 101, 102) on the basis of the content and/or type of free radicals in the oil determined by the free radical sensor (9).

4. A device as claimed in claim 1, and comprising a heat exchanger (7) located upstream from the first electrostatic cleaner (10; 101, 102) to cool the oil.

5. A device as claimed in claim 4, wherein the heat exchanger (7) is an air-type heat exchanger.

6. A device as claimed in claim 5, wherein the heat exchanger (7) comprises at least a ventilator (18); the device (1) comprising a control device (13) configured to regulate the speed of the ventilator (19) on the basis of the content and/or type of free radicals in the oil determined by the free radical sensor (9).

7. A device as claimed in claim 1, and comprising a pump (18) for drawing oil from an oil tank (3), and which is located upstream from the first electrostatic cleaner (10; 101, 102); the device (1) comprising a control device (13) configured to regulate the amount of oil drawn by the pump (18) on the basis of the content and/or type of free radicals in the oil determined by the free radical sensor (9).

8. A device as claimed in claim 1, and comprising a second electrostatic cleaner (101, 102); the first electrostatic cleaner (101) and the second electrostatic cleaner (102) being connected to each other to operate selectively in:
a first mode, in which only one of the first (101) and second (102) electrostatic cleaners is active;
a second mode, in which oil flows through the first electrostatic cleaner (101) and the second electrostatic cleaner (102) in series; and
a third mode, in which oil flows through the first electrostatic cleaner (101) and the second electrostatic cleaner (102) in parallel.

9. An oil cleaning method comprising the steps of:
cleaning the oil by means of at least a first electrostatic cleaner (10; 101, 102) comprising at least a voltage source (24), and at least two metal plates (21) connected to said voltage source (24); and
determining the content and/or type of free radicals in the oil.

10. A method as claimed in claim 9, and comprising the step of determining the content and/or type of free radicals prior to the step of cleaning the oil by means of at least a first electrostatic cleaner (10; 101, 102).

11. A method as claimed in claim 9, and comprising the step of adjusting the voltage of the voltage source (24) of the first electrostatic cleaner (10; 101, 102) on the basis of the content and/or type of free radicals in the oil determined by the free radical sensor (9).

12. A method as claimed in claim 9, and comprising the step of cooling the oil prior to the step of cleaning the oil by means of at least a first electrostatic cleaner (10; 101, 102).

13. A method as claimed in claim 12, wherein the step of cooling the oil comprises the step of regulating a cooling speed on the basis of the content and/or type of free radicals in the oil determined by the free radical sensor (9).

14. A method as claimed in claim 9, and comprising the step of drawing oil from an oil tank (3) prior to the step of cleaning the oil by means of at least a first electrostatic cleaner (10; 101, 102).

15. A method as claimed in claim 14, wherein the step of drawing oil comprises the step of regulating an amount of oil drawn on the basis of the content and/or type of free radicals in the oil determined by the free radical sensor (9).

16. A method as claimed in 9, and comprising the step of connecting a first electrostatic cleaner (101) and a second electrostatic cleaner (102) to each other, so as to operate selectively in:
a first mode, in which only one of the first (101) and second (102) electrostatic cleaners is active;
a second mode, in which oil flows through the first electrostatic cleaner (101) and the second electrostatic cleaner (102) in series; and
a third mode, in which oil flows through the first electrostatic cleaner (101) and the second electrostatic cleaner (102) in parallel.
